(19) United States
(12) Patent Application Publication
(10) Pub. No.: US 2013/0122860 A1
(43) Pub. Date: May 16, 2013

(54) METHOD FOR PROVIDING A MONITORING OF USAGE NETWORK RESOURCES OF A USER SESSION WITHIN A NETWORK AND A NETWORK DEVICE

(71) Applicants: Aditya Dhruva, Bangalore (IN); Sanjiv Kumar Ojha, Murugeshpalya (IN)

(72) Inventors: Aditya Dhruva, Bangalore (IN); Sanjiv Kumar Ojha, Murugeshpalya (IN)

(73) Assignee: NOKIA SIEMENS NETWORKS OY, ESPOO (FI)

(21) Appl. No.: 13/811,719

(22) PCT Filed: Jul. 20, 2011
(86) PCT No.: PCT/EP2011/062430

§ 371 Date: Jan. 23, 2013

Related U.S. Application Data
(60) Provisional application No. 61/357,010, filed on Jun. 21, 2010.

(51) Int. Cl. H04W 4/26

(52) U.S. Cl. CPC H04W 4/26
USPC 455/406

(57) ABSTRACT

A method monitors usage of network resources of a user session within a network. The method includes receiving a first message at a first policy and charging function device, the first message may be sent by a second policy and charging function device and the first message may contain a credit control request (CCR). Moreover, the method sends a second message from the first policy and charging function device to the second policy and charging function device, the second message may contain a credit control answer (CCA). The method may further includes sending a third message from the first policy and charging function device to the second policy and charging function device, the third message may contain monitoring information for non-disabling the monitoring of usage network resources of the user session.

### TECHNICAL FIELD

Embodiments of the present invention relate generally to mobile communications and more particularly to network devices and methods in communication networks. The invention relates to a method for providing a monitoring of usage network resources of a user session within a network. Moreover, the invention relates to network devices, to a network system, to a computer-readable medium and a program product.

### BACKGROUND

Networks, in particular communication networks may comprise charging aspects. Currently 3GPP is in progress of defining Usage Monitoring Control, in particular in 3GPP TS 29.212 4.5.16, release 9. In this document a specification for the charging and policy control over the interface Gx reference point is provided. The Gx reference point may be located between a policy and charging rules function (PCRF) and a policy and charging enforcement function (PCEF). The Gx reference point may be used for provisioning and removal of policy and charging control (PCC) rules from the PCRF to the PCEF and the transmission of traffic plane events from the PCEF to the PCRF. The Gx reference point may be used for charging control, policy control or both by applying attribute value pair (AVP) relevant to the application. The AVP may be utilized to encapsulate protocol-specific data such as routing information, as well as authentication, authorization or accounting information.

FIG. 1 shows an architecture with a Gx reference point or Gx-interface connecting a policy and charging rules function with a policy and charging enforcement function, FIG. 1 illustrates further network devices within the architecture of the network, in particular a subscription profile repository (SPR), an application function (AF), a bearer binding and event reporting function (BBERF), an online charging system (OCS) and an offline charging system (OFCS). In addition to the Gx reference point shown in FIG. 1 further interfaces may be provided, such as a Rx-Interface, a Sp-interface, a Gxx-interface, a Gy-interface and a Gz-Interface.

Usage monitoring control may enable the PCRF to monitor the accumulated usage network resources on per IP-CAN session and user bases. For modifying an existing monitoring session the 3GPP specifies firstly, disabling the usage monitoring and secondly enabling the usage monitoring after disabling it.

An exemplary embodiment for modifying an existing monitoring session according to the 3GPP specification is illustrated in FIG. 2. In FIG. 2 information may be exchanged between a PCRF and a PCEF. In a first message a credit control request (CCR) may be sent from the PCEF to the PCRF. Then a credit control answer (CCA) may be sent from the PCRF to the PCEF comprising usage monitoring information. A granted service interface (GSU) may provide 10 Mbit for a monitoring key X. After receiving the credit control answer message by the PCEF, the PCEF may receive a further third message, which may be a re-authentication request message (RAR) comprising a usage-monitoring-support AVP. This usage-monitoring-support AVP may be set to a value for “disabling” the usage monitoring.

In other words, to disable usage monitoring for a monitoring key, the PCRF may send the usage-monitoring-information AVP comprising the applicable monitoring key within the monitoring-key AVP and the usage monitoring support AVP may be set to USAGE_MONITORING_DISABLED. When the PCRF may disable usage monitoring in an RAR or CCA command, the PCEF may send a new CCR command to report accumulated usage for the disabled usage monitoring key(s).

In FIG. 2 the PCEF may send a further message to the PCRF after having sent the re-authentication answer message (RAA). The following message may be a credit control request message, comprising a CCR update. This credit control request may comprise a usage monitoring information for the monitoring key X and a used service interface of 5 MB.

With other words for enabling the usage monitoring the PCRF, after having received the CCR with the reported accumulated usage for disabled usage monitoring key, may send a CCA message with a new threshold for the same monitoring key, here monitoring key X.

According to FIG. 2 it may be observed, that restart of monitoring may require an exchange of several messages, in FIG. 2 four messages. These messages in turn may expect processing at the end of both the PCEF and the PCRF. Thus, it may be necessary to provide an increased signalling traffic to restart the monitoring.

There may be a need to simplify the usage monitoring control and to reduce required signalling traffic.

### SUMMARY OF THE INVENTION

According to an exemplary embodiment of the present invention there is provided a method for providing a monitoring of usage network resources of a user session within a network. The method may comprise receiving a first message at a first policy and charging function device, wherein the first message may be sent by a second policy and charging function device, wherein the first message may comprise a credit control request (CCR). Moreover, the method may further comprise sending a second message from the first policy and charging function device to the second policy and charging function device, wherein the second message may comprise a credit control answer (CCA). Furthermore, the method may comprise sending a third message from the first policy and charging function device to the second policy and charging function device, wherein the third message may comprise monitoring information for non-disabling the monitoring of usage network resources of the user session.

The first device may be a PCRF. The second device may be a PCEF. The PCEF may be a functional element that may encompass policy control decision and flow-based charging control functionalities. These functionalities may be the heritage of logical entities PDF and CRF, respectively. The PCRF may provide network control regarding the service data flow detection, grating, Quality of Service (QoS) and flow-based charging towards the PCEF. The PCRF may receive session and media-related information from the AF and may inform AF of traffic plane events. The PCRF may provision PCC rules to the PCEF via a Gx reference point or Gx-interface.

The PCEF (policy and charging enforcement function) may be the functional element that may encompass policy enforcement and flow-based charging functionalities. These functionalities may be the heritage of logical entities PEP and TPF, respectively. These functional entities may be located at the gateway, in example GGSN in the GPRS case and PDG in the WLAN case. It may provide control over the user plane traffic handling at the gateway and its QoS, and may provide service data flow detection and counting as well as online and offline charging interactions.

If requested by the PCRF, the PCEF may report to the PCRF when the status of the related service data flow may change. This procedure may be used to monitor an IP-CAN bearer dedicated for AF signalling traffic.

According to an exemplary embodiment of the present invention it may be foreseen that the monitoring information is an update information or a restart information.

According to an exemplary embodiment of the present invention it may be foreseen that the third message may be a re-authorization request message (RAR).

The credit control request (OCR) message and the re-authorization request message (RAR) may be suitable for monitoring a monitoring key.

According to an exemplary embodiment of the present invention there may be provided a method, which further may comprise providing a threshold.

Threshold levels may be defined for the total volume only, or the uplink volume only, or the downlink volume only, or the uplink and downlink volume in combination.

According to an exemplary embodiment of the present invention there may be provided a method, which further may comprise updating the threshold.

Modifying or updating the threshold may be performed periodically in time or triggered by an event. A threshold may be a value or an event which may trigger sending a message.

According to an exemplary embodiment of the present invention there may be provided a method, wherein the second message may comprise the threshold and wherein the third message may comprise the updated threshold.

An updated threshold may be also a value which may be identical with the previous threshold. The updating may confirm the previous threshold.

According to an exemplary embodiment of the present invention it may be foreseen that the threshold may comprise a threshold value provided in the second message.

According to an exemplary embodiment of the present invention it may be foreseen that the monitoring information for non-disabling the monitoring of usage network resources of the user session may be implemented in an attribute value pair parameter (AVP) of the third message.

According to an exemplary embodiment of the present invention the method may comprise sending a fourth message from the second policy and charging function device to the first policy and charging function device, wherein the fourth message may be a re-authorization answer message (RAA).

With other words, the monitoring may be not be interrupted but may be continued with a further or additional threshold, which may be higher or lower than the previous threshold utilized for the previous monitoring within the same session of the user.

According to an exemplary embodiment of the present invention the method may further comprise initiating a continuation of the ongoing monitoring utilizing the updated threshold or an additional threshold for the ongoing monitoring with the fourth message.

According to an exemplary embodiment of the present invention there may be provided a first network device comprising a receiving interface and a sending interface; wherein the receiving interface may be adapted for receiving a first message, wherein the first message may be sent by a second network device and wherein the second network device may be a policy and charging function device. Moreover, the first message may comprise a credit control request (CCR). Furthermore, the sending interface may be adapted for sending a second message to the second policy and charging function device, wherein the second message may comprise a credit control answer (CCA) and wherein the sending interface may be adapted for sending a third message to the second policy and charging function device. Moreover, the third message may comprise monitoring information for non-disabling the monitoring of usage network resources of a user session.

The first network device may be a PCRF.

According to an exemplary embodiment of the present invention there may be provided a second network device comprising a receiving interface and a sending interface, wherein the sending interface may be adapted to send a first message to a policy and charging function device. Moreover, the first message may comprise a credit control request (CCR); wherein the receiving interface may be adapted to receive a second message from the first policy and charging function device. Furthermore the second message may comprise a credit control answer (CCA) and the receiving interface may be adapted to receive a third message, wherein the third message may comprise monitoring information for non-disabling the monitoring of usage network resources of the user session.

The second network device may be a PCEF.

According to an exemplary embodiment of the present invention there may be provided a network system comprising the first network device and the second network device, wherein the first network device and the second network device may be connected over an interface.

The interface may be a wireline or a wireless interface.

According to an exemplary embodiment of the present invention it may be foreseen that the first network device may be a policy and charging rules function device (PCRF) and the second network device may be a policy and charging enforcement function (PCEF), wherein the interface may be a Gx-interface.

A Gx-interface may be an interface between the traffic plane function of a gateway GPRS support node (GGSN) and the charging rules function of a connection processing server (CPS). The Diameter base protocol may be utilized in the Gx-interface. Moreover, the Gx-interface may be a Gx reference point, for example a Gxa reference point, a Gxb reference point or a Gxc reference point. A reference point may be present between a packet data network gateway and the policy and charging rules function.

A Gx reference point may be utilized to transfer the policy and charging information from the policy and charging rules function to the policy and charging enforcement function in the packet data network gateway.

A Gxa reference point may be utilized for transferring policy and charging information from the policy and charging rules function to a trusted non-3GPP access network, for example, WLAN and WiMAX are non-3GPP access networks.

A Gxb reference point may be a Gx reference point between the policy and charging rules function and an evolved packet data gateway.

A Gxc reference point may be a Gx reference point for transferring policy and charging information from the policy and charging rules function to a serving gateway when the IETF variant of S5 and S8 reference points may be used.

According to an exemplary embodiment of the present invention there may be provided a computer program product comprising code portions for causing a network device, on which the computer program may be executed to carry out the method according to an exemplary embodiment of the present invention.

According to an exemplary embodiment of the present invention there may be provided a computer-readable medium embodying the computer program product, wherein the computer program product may comprise code portions for causing a network device, on which the computer program may be executed to carry out the method according to an exemplary embodiment of the present invention.

A computer-readable medium may comprise a computer-readable storage medium that may be any media or means that can contain or store the instructions for use by or in connection with an instruction execution system, apparatus, or device, such as a computer.

### BRIEF DESCRIPTION OF THE DRAWINGS

Embodiments of the present invention are described below with reference to the accompanying drawings, which are not necessary drawn to scale, wherein:

FIG. 1 illustrates a network architecture according to an exemplary embodiment,

FIG. 2 illustrates a message flow diagram according to an exemplary embodiment,

FIG. 3 illustrates a message flow diagram according to a first exemplary embodiment,

FIG. 4 illustrates a message flow diagram according to a second exemplary embodiment of the present invention,

FIG. 5 illustrates a message flow diagram according to a third exemplary embodiment of the present invention,

FIG. 6 illustrates a message flow diagram according to a fourth exemplary embodiment of the present invention,

FIG. 7 illustrates a message flow diagram according to a fifth exemplary embodiment of the present invention,

FIG. 8 illustrates a message flow diagram according to a sixth exemplary embodiment of the present invention,

FIG. 9 illustrates a message flow diagram according to a seventh exemplary embodiment of the present invention, and

FIG. 10 illustrates an exemplary embodiment of a method according to the present invention.

### DETAILED DESCRIPTION

The illustration of the drawings is schematic. In different drawings, similar or identical elements are provided with the same reference numerals.

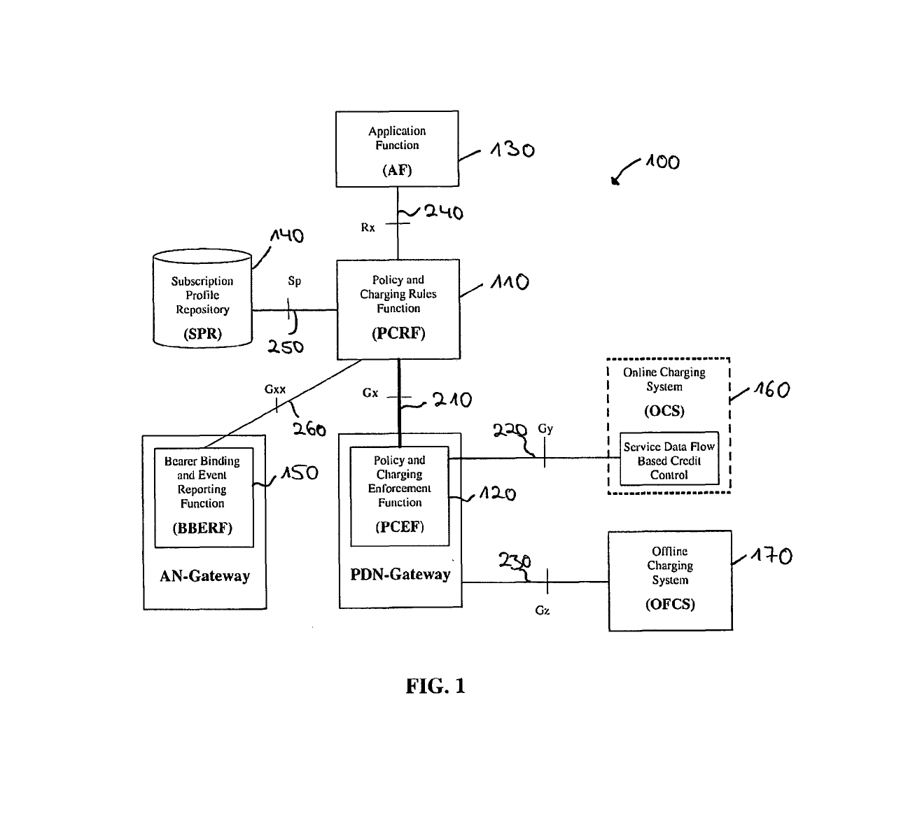

FIG. 1 illustrates an architecture within a 3GPP environment as already described above. A network 100 comprises a policy and charging rules function (PCRF) 110, a policy and charging enforcement function (PCEF) 120, an application function (AF) 130, a subscription profile repository (SPR) 140, a bearer binding and event reporting function (BBERF) 150, an online charging system (OCS) 160 and an offline charging system (OFCS) 170. Moreover, in FIG. 1 a plurality of interfaces between network devices are illustrated, such as a Gx-interface 210, a Gy-interface 220, a Gz-interface 230, an Rx-interface 240, a Sp-interface 250, and a Gxx-interface 260.

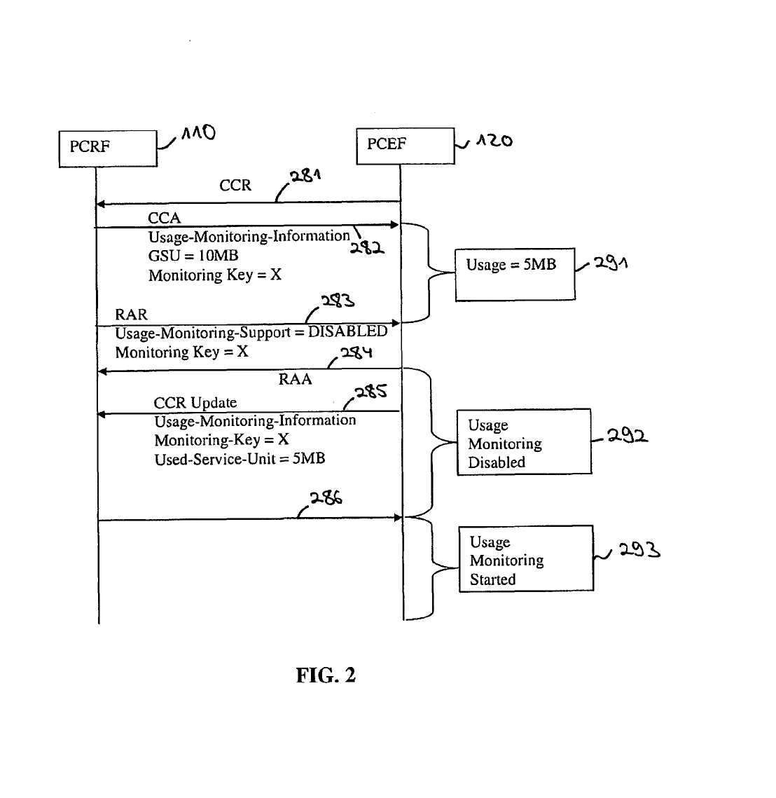

FIG. 2 illustrates a method within a message flow diagram according an exemplary embodiment suggested by 3GPP standard, as described above. The method may comprise sending and receiving messages 281, 282, 283, 284, 285 and 286. Between sending of message 282 and sending of message 283 a usage of 5 MB may be provided as indicated by 291. Timely from sending message 284 to sending message 286 a usage monitoring may be disabled, as indicated by 292. After sending message 286 a usage monitoring may be restarted with a new threshold or an updated threshold as indicated by 293.

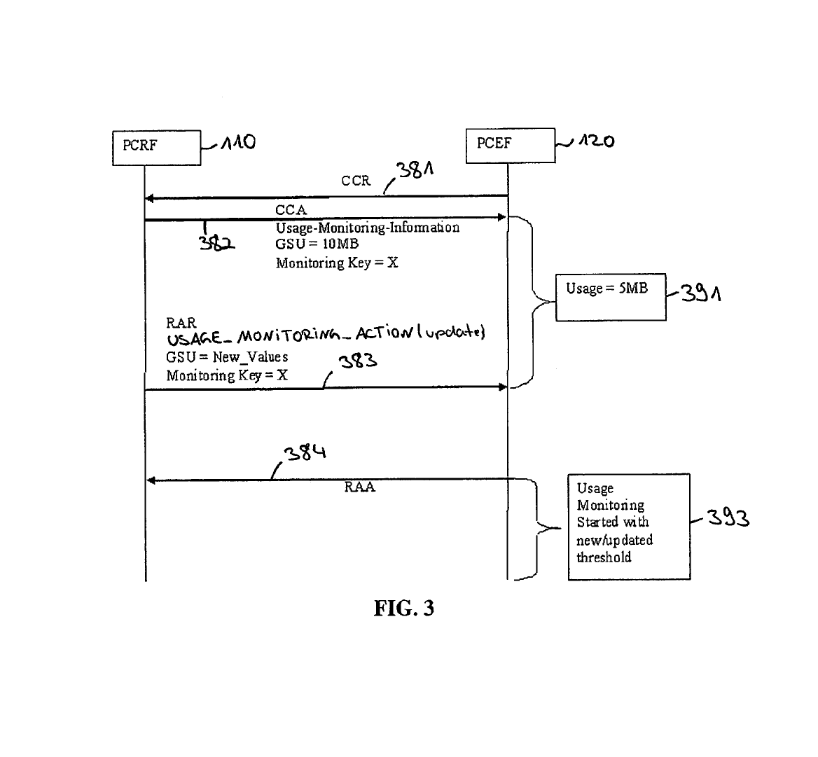

FIGS. 3, 4, 5, 6, 7, 8 and 9 illustrate exemplary embodiments of the present invention. FIGS. 3, 4, 5, 6, 7, 8 and 9 shows a PCRF 110 and a PCEF 120, which are connected to each other over a Gx-interface 210 or a Gx reference point 210. The Gx-interface 210 may be utilized for provisioning and removal of PCC rules from the PCRF 110 to the PCEF 120 and the transmission of traffic plane events from the PCEF 120 to the PCRF 110. Moreover, the Gx-interface 210 may be utilized for charging control, policy control or both by applying AVPs relevant to the application of the user.

FIGS. 3, 4, 5, 6, 7, 8 and 9 may illustrate exemplary embodiments as alternatives comprising several messages for performing the method according to the present invention. In a first step a CCR message 381, 481, 581, 681, 781, 881, 981 may be sent from the PCEF 120 to the PCRF 110. After having received this CCR message 381, 481, 581, 681, 781, 881, 981 the PCRF 110 may send a CCA message 382, 482, 582, 682, 782, 882, 982 to the PCEF 120. This message may comprise a Usage-Monitoring Information. In the exemplary embodiments of FIGS. 3, 4, 5, 6, 7, 8 and 9 there may be provided a GSU of 10 MB. A Monitoring Key for this GSU may be monitoring key X. Before the GSU of 10 MB may be utilized a RAR message 383, 483, 583, 683, 783, 883, 983 may be sent from the PCRF 110 to the PCEF 120, The RAR message may be provided in order not to disable the monitoring but to continue the monitoring. Therefore the RAR message 383, 483, 583, 683, 783, 883, 983 may comprise parameters which may allow the PCEF 120 to continue its service.

In FIG. 3 the RAR message 383 may comprise an AVP, i.e. a Usage-Monitoring-Action message comprising an update parameter, i.e. USAGE_MONITORING_ACTION (update).

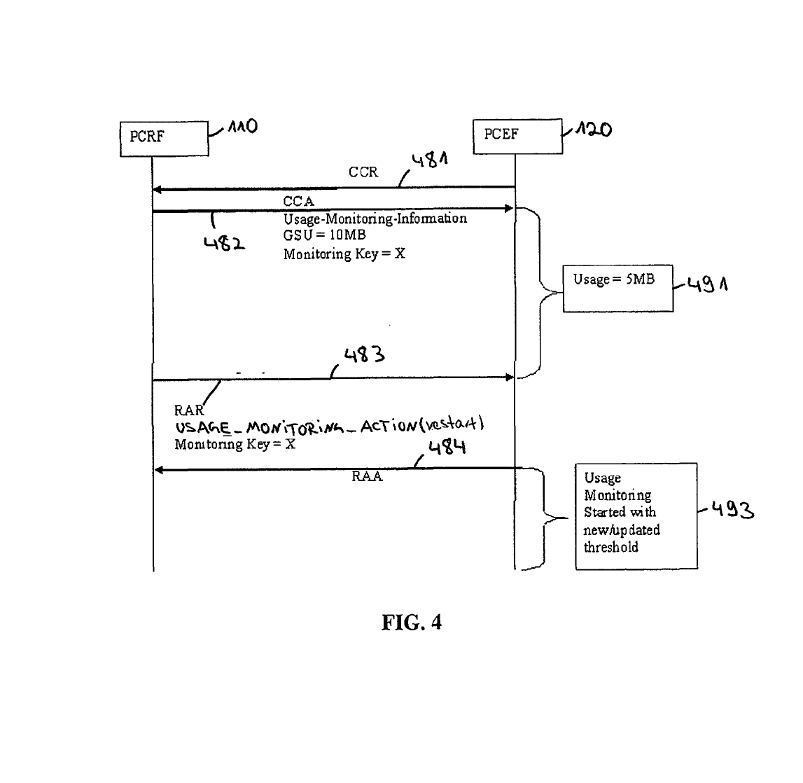

In FIG. 4 the RAR message 483 may comprise an AVP, i.e. a Usage-Monitoring-Action message comprising a restart parameter, i.e. USAGE_MONITORING_ACTION (restart).

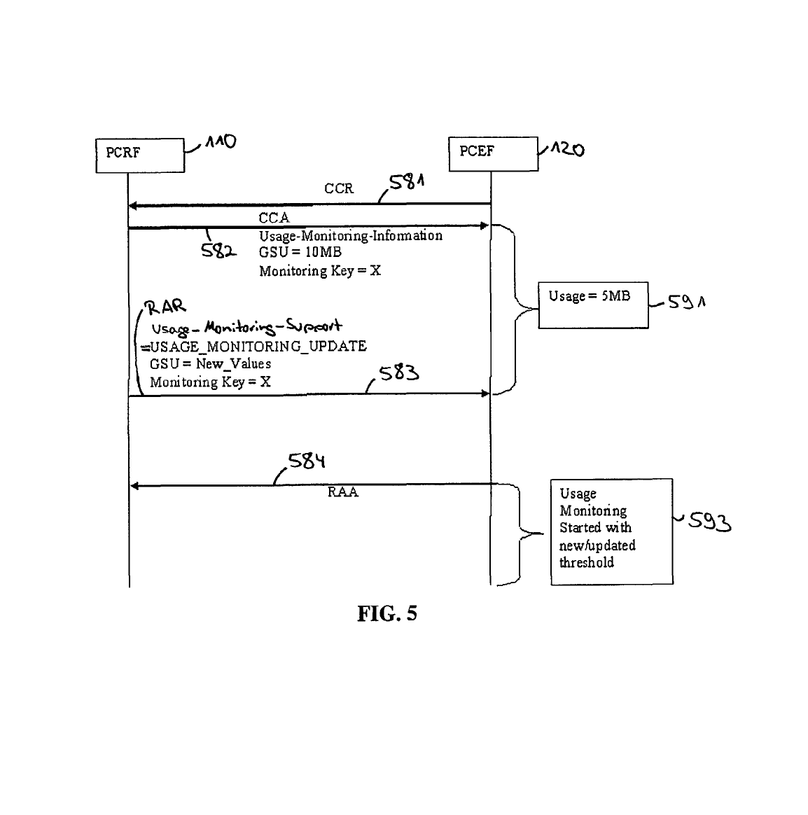

In FIG. 5 the RAR message 583 may comprise a modified message introducing a parameter in relation to update i.e. a message USAGE_MONITORING_UPDATE. For the update the GSU may comprise a new value for the further procedure. Moreover, the monitoring key may remain as monitoring key X as utilized in CCA message 582.

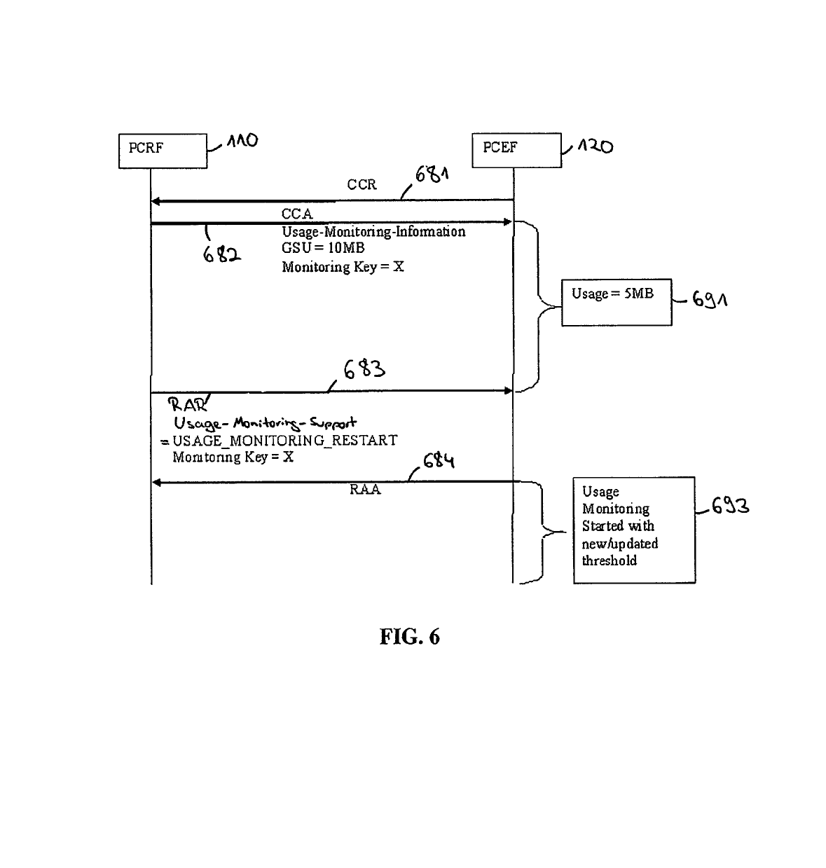

In FIG. 6 the RAR message 683 may comprise a modified message introducing a parameter in relation to a restart i.e. a message USAGE_MONITORING_RESTART. For the restart no further GSU value may be necessary. Moreover, the monitoring key may remain as monitoring key X as utilized in CCA message 682.

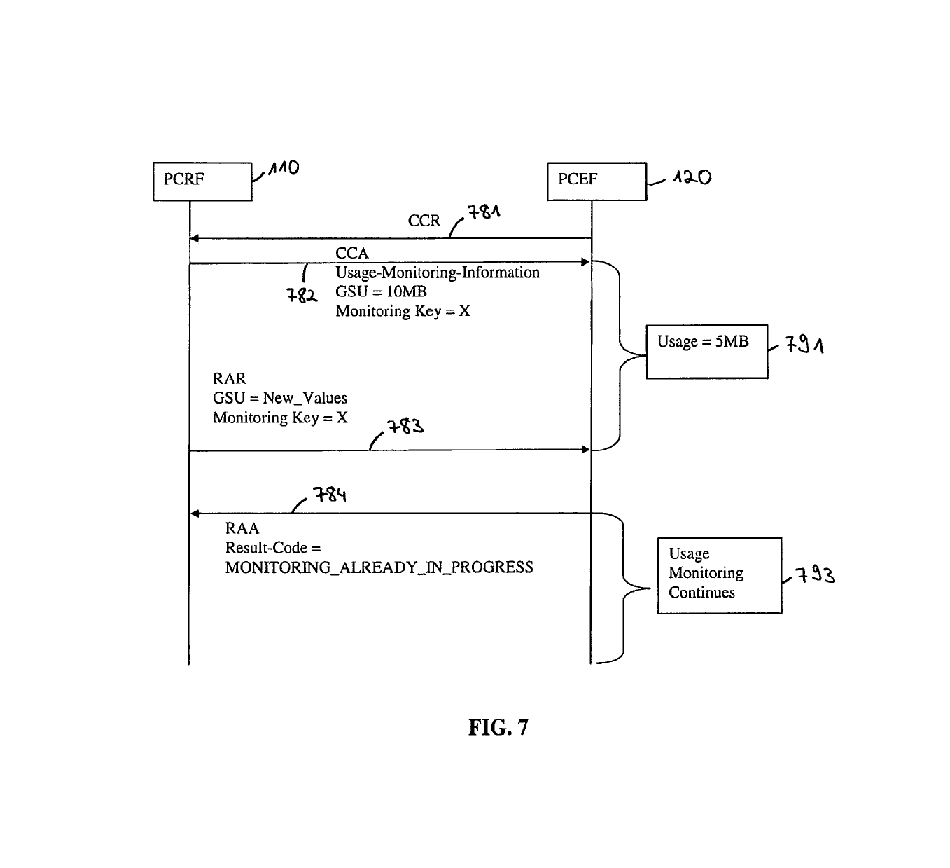

In FIG. 7 a RAR message 783 may not comprise a USAGE_MONITORING_UPDATE but may comprise a new GSU. The new GSU may result in an error code in RAA 784 from PCEF 120. The error code may state that Usage Monitoring is already ongoing.

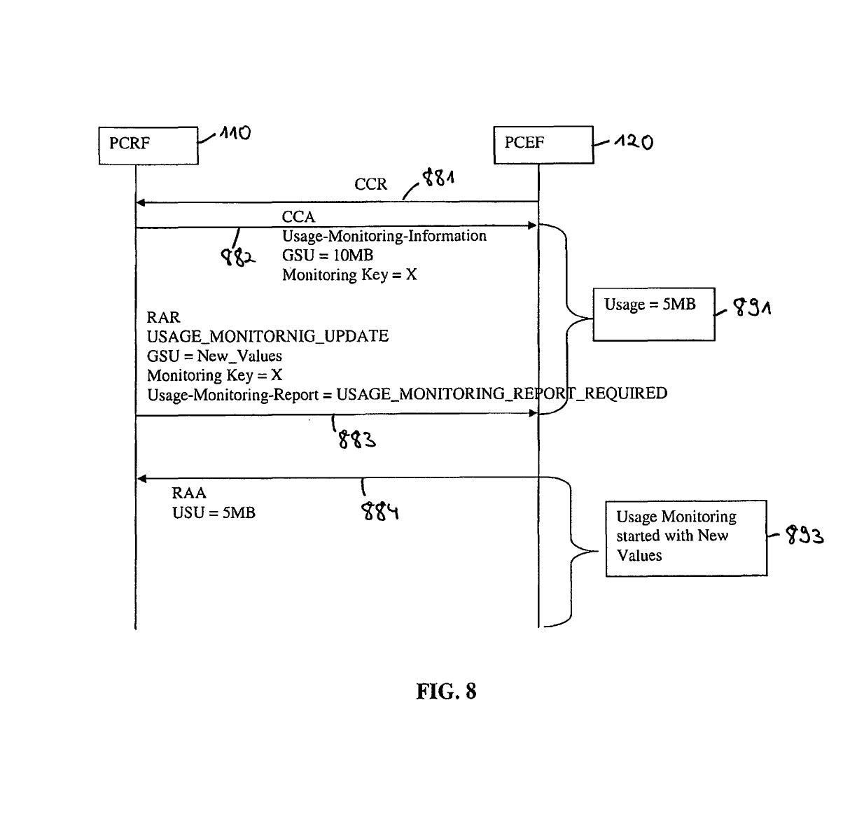

In FIG. 8 optionally the PCRF 110 may comprise Usage-Monitoring-Report AVP set to value USAGE_MONITORING_REPORT_REQUIRED. This value may be utilized in case the PCRF 110 wishes to know the usage until the RAR message 883 is sent.

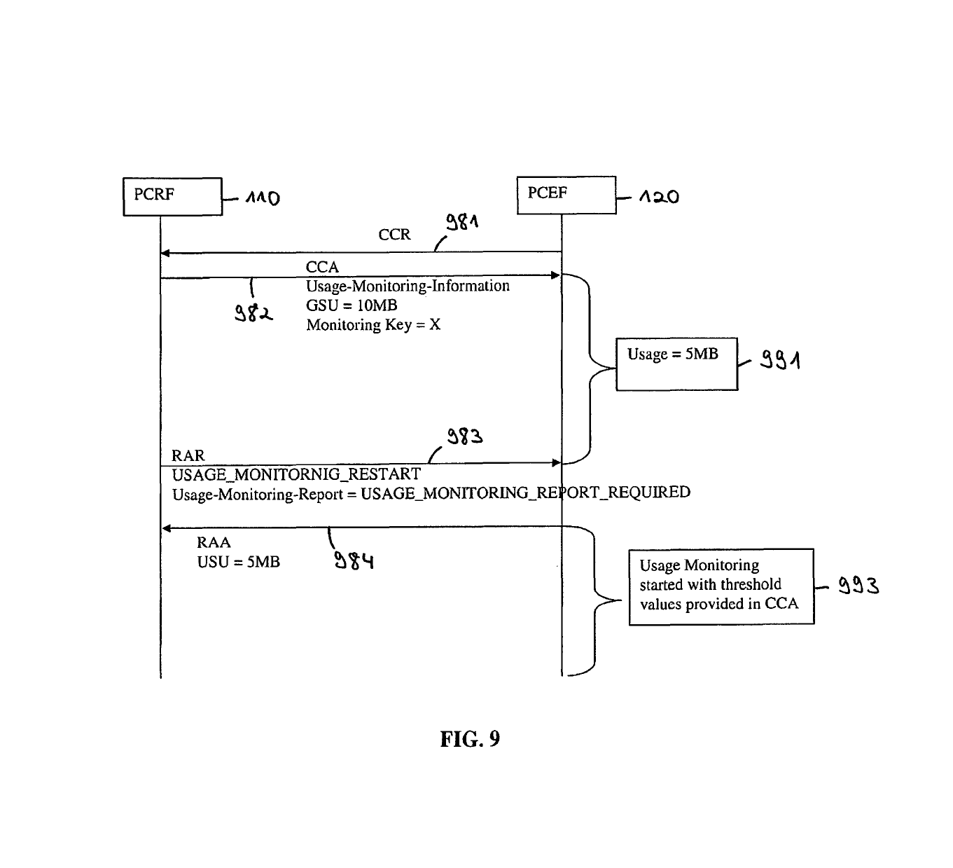

In FIG. 9 it is illustrated a Usage-Monitoring-Information, which may be part of a RAA 984. Thus, for example in a 3GPP environment the Usage-Monitoring-Information may be included in the RAA message. The Usage-Monitoring-Information AVP may have a sub AVP, wherein the Used-Service-Units may comprise the usage reported by the PCEF 120.

The messages 383, 484, 583, 683, 783, 883, 983 may be utilized in order to avoid a disablement of the ongoing monitoring. In contrast to the situation illustrated in FIG. 2, the exemplary embodiments according to FIGS. 3, 4, 5, 6, 7, 8 and 9 may avoid a latency involved in starting the updated monitoring at the PCEF 110. This latency may result in a loss of important monitoring information within that period, which may be reduced or avoided according to exemplary embodiments of the present invention. Thus, a risk for losing information which may vary from a few bytes to many Mbits depending on the throughput at the transport layer may be avoided, as shown in FIGS. 3, 4, 5, 6, 7, 8 and 9.

In FIGS. 3, 4, 5, 6, 7, 8 and 9 the PCEF 120 may send a RAA message 384, 484, 584, 684, 784, 884, 984 to the PCRF 110. Then a usage monitoring may be started with a new threshold or an updated threshold as indicated by 393, 493, 593, 693, 793, 893, 993.

The PCRF 110 may request an update and/or a restart of usage monitoring in a single message. Thus there may be a reduction in network traffic. This may also avoid a delay in starting the updated and/or new monitoring. Moreover, this may result in avoiding loss of crucial data that may be monitored. On implementing monitoring information for non-disabling the monitoring of the user session a loss of monitoring information may be reduced or eliminated. As a result network operators may have advantages when operating their networks.

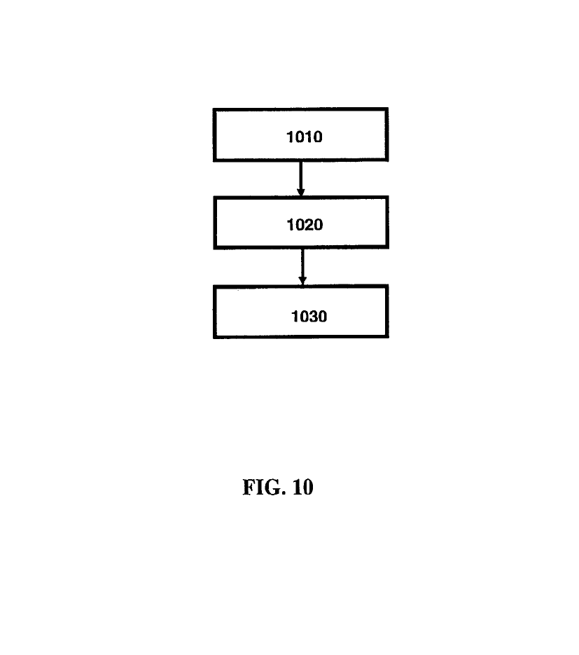

FIG. 10 illustrates an exemplary embodiment of a method according to the present invention. The method may comprise a first step 1010, a second step 1020 and a third step 1030. Further steps may also be provided, for example as illustrated in the previous Figures and described above. The method may provide a monitoring of usage network resources of a user session within a network.

The method may comprise as first step 1010 receiving a first message 381, 481, 581, 681, 781, 881, 981 at a first policy and charging function device 110, wherein the first message 381, 481, 581, 681, 781, 881, 981 may be sent by a second policy and charging function device 120, wherein the first message 381, 481, 581, 681, 781, 881, 981 may comprise a credit control request (OCR).

In the second step 1020 it may be foreseen sending a second message 382, 482, 582, 682, 782, 882, 982 from the first policy and charging function device 110 to the second policy and charging function device 120, wherein the second message 382, 482, 582, 682, 782, 882, 982 may comprise a credit control answer (CCA).

In a third step 1030 the method may provide sending a third message 383, 483, 583, 683, 783, 883, 983 from the first policy and charging function device 110 to the second policy and charging function device 120, wherein the third message 383, 483, 583, 683, 783, 883, 983 may comprise monitoring information for non-disabling the monitoring of usage network resources of the user session.

In general, it is to be noted that respective functional elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Furthermore, method steps and functions likely to be implemented as software code portions and being run using a processor at one of the entities are software code independent and can be specified using any known or future developed programming language such as e.g. Java, C++, C, and Assembler. Method steps and/or devices or means likely to be implemented as hardware components at one of the entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

The network devices or network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

For the purpose of the present invention as described herein above, it should be noted that:
an access technology via which signaling is transferred to and from a network element or node may be any technology by means of which a node can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable access networks may be any device, apparatus, unit or means by which a station, entity or other user equipment may connect to and/or utilize services offered by the access network; such services include, among others, data and/or (audio-) visual communication, data download etc.;
a user equipment may be any device, apparatus, unit or means by which a system user or subscriber may experience services from an access network, such as a mobile phone, personal digital assistant PDA, or computer;
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

Although described above mainly with respect to methods, procedures, an apparatus and modules thereof, it is to be understood that the present invention also covers a computer program products for implementing such methods or procedures and/or for operating such apparatuses or modules, as well as computer-readable (storage) media for storing such computer program products. The present invention also covers any conceivable combination of method steps and operations described above, and any conceivable combination of nodes, apparatuses and modules described above, as long as the above-described concepts of methodology and structural arrangement are applicable.

Furthermore, the network devices or network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

It may be foreseen that the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

It should be noted, that reference signs in the claims shall not be construed as limiting the scope of the claims.

In this context, “first”, “second”, “third”, etc. in relation to devices, network devices, interfaces, messages, etc. may not be understood as hierarchy, it should be understood only to distinguish different devices or interfaces or messages, etc. from each other.

### LIST OF ABBREVIATIONS

3GPP Third Generation Partnership Project
AF Application Function
AVP Attribute Value Pair
BBERF Bearer Binding and Event Reporting Function
CCA Credit Control Answer
CCR Credit Control Request
GSU Granted Service Interface
OCS Online Charging System
OFCS Offline Charging System
PCC Policy and Charging Control
PCEF Policy and Charging Enforcement Function
PCRF Policy and Charging Rules Function
RAA Re-authorization Answer
RAR Re-authorization Request
SPR Subscription Profile Repository

1-16. (canceled)

17. A method for monitoring usage of network resources during a user session within a network, which comprises the steps of:
receiving a first message at a first policy and charging function device, the first message being sent by a second policy and charging function device, the first message containing a credit control request;
sending a second message from the first policy and charging function device to the second policy and charging function device, the second message containing a credit control answer; and
sending a third message from the first policy and charging function device to the second policy and charging function device, the third message containing monitoring information for non-disabling the monitoring of the usage of the network resources during the user session.

18. The method according to claim 17, wherein the monitoring information is update information or restart information.

19. The method according to claim 17, wherein the third message is a re-authorization request message.

20. The method according to claim 17, which further comprises providing a threshold.

21. The method according to claim 20, which further comprises updating the threshold.

22. The method according to claim 20, wherein the second message contains the threshold and the third message contains an updated threshold.

23. The method according to claim 20, wherein the threshold contains a threshold value provided in the second message.

24. The method according to claim 17, wherein the monitoring information for non-disabling the monitoring of the usage of the network resources during the user session is implemented in an attribute value pair parameter of the third message.

25. The method according to claim 17, which further comprises sending a fourth message from the second policy and charging function device to the first policy and charging function device, the fourth message is a re-authorization answer message.

26. The method according to claim 25, which further comprises initiating a continuation of an ongoing monitoring utilizing an updated threshold or an additional threshold for the ongoing monitoring with the fourth message.

27. A first network device, comprising:
a receiving interface adapted for receiving a first message, the first message being sent by a second network device and the second network device is a policy and charging function device, the first message containing a credit control request; and
a sending interface adapted for sending a second message to the policy and charging function device, the second message containing a credit control answer, said sending interface further adapted for sending a third message to the policy and charging function device, the third message containing monitoring information for non-disabling monitoring of usage of network resources during a user session.

28. A second network device, comprising:
a sending interface adapted to send a first message to a policy and charging function device, the first message containing a credit control request; and
a receiving interface adapted to receive a second message from the policy and charging function device, the second message containing a credit control answer, said receiving interface adapted to receive a third message, the third message containing monitoring information for non-disabling a monitoring of usage of network resources during a user session.

29. A network system, comprising:
a first network device being a first policy and charging function device;
a second network device being a second policy and charging function device;
said first network device, containing:
a first receiving interface adapted for receiving a first message, the first message being sent by said second network device, the first message containing a credit control request; and
a first sending interface adapted for sending a second message to said second policy and charging function device, the second message containing a credit control answer, said first sending interface further adapted for sending a third message to said second policy and charging function device, the third message containing monitoring information for non-disabling a monitoring of usage of network resources during a user session;
said second network device, containing:
a second sending interface adapted to send the first message to said first policy and charging function device, the first message containing the credit control request; and
a second receiving interface adapted to receive the second message from said first policy and charging function device, the second message containing the credit control answer, said second receiving interface adapted to receive the third message, the third message containing the monitoring information for non-disabling the monitoring of the usage of the network resources of during the user session;
an interface connecting said first network device to said second network device.

30. The network system according to claim 29, wherein:
said first network device is a policy and charging rules function device;
said second network device is a policy and charging enforcement function device; and
said interface is a Gx-interface.

31. A non-transitory computer memory, comprising:
a computer program product having code portions for causing a network device, on which the computer program may be executed to carry out a method for providing a monitoring of usage of network resources during a user session within the network device, which comprises the steps of:
receiving a first message at a first policy and charging function device, the first message being sent by a second policy and charging function device, the first message containing a credit control request;
sending a second message from the first policy and charging function device to the second policy and charging function device, the second message containing a credit control answer; and
sending a third message from the first policy and charging function device to the second policy and charging function device, the third message containing monitoring information for non-disabling the monitoring of the usage of the network resources during the user session.

32. A computer program product having code portions for causing a network device, on which the computer program may be executed to carry out a method for providing a monitoring of usage of network resources during a user session within the network device, which comprises the steps of:
receiving a first message at a first policy and charging function device, the first message being sent by a second policy and charging function device, the first message containing a credit control request;
sending a second message from the first policy and charging function device to the second policy and charging function device, the second message containing a credit control answer; and
sending a third message from the first policy and charging function device to the second policy and charging function device, the third message containing monitoring information for non-disabling the monitoring of the usage of the network resources during the user session.
